(19) United States
(12) Patent Application Publication
(10) Pub. No.: US 2023/0407924 A1
(43) Pub. Date: Dec. 21, 2023

(54) TORQUE DEVICE AND SYSTEMS AND METHODS THEREOF

(71) Applicant: Caterpillar Inc., Peoria, IL (US)

(72) Inventors: Raymond B. DERER, Peoria, IL (US); Ian L. MACDONALD, Hoffman Estates, IL (US); Nathan J. ADAMS, Metamora, IL (US); Yunbo WANG, Palo Alto, CA (US); Benjamin J. KUNZEMAN, Dunlap, IL (US)

(73) Assignee: Caterpillar Inc., Peoria, IL (US)

(21) Appl. No.: 17/842,802

(22) Filed: Jun. 17, 2022

(51) Int. Cl. F16D 25/0638; F16D 25/10

(52) U.S. Cl. CPC F16D 25/0638; F16D 25/10

(57) ABSTRACT

Systems, methods, and assemblies regarding a torque device can comprise at least one plate having a contact face; and a piston of the torque device assembly to slidingly engage and disengage with the contact face of the plate. A face of the piston can be selectively engageable with the contact face of the plate. The face of the piston can have a first portion that faces the contact face of the plate and that can contact the contact face of the plate in a case where the piston engages the plate. The face of the piston can have a second portion that faces the contact face of the plate and that does not contact the contact face of the plate in the case where the piston engages the plate.

### TECHNICAL FIELD

The present disclosure relates to torque devices, particularly torque devices (e.g., clutch or brake) in transmissions or braking systems.

### BACKGROUND

In a transmission system or a brake system, a piston can be used to engage or clamp the torque device (e.g., clutch or brake) to bring all components to the same rotational speed. Some designs have part deflection which can create high concentrated loading on the friction material. Such deflection may also lead to high localized temperatures during engagement.

U.S. Pat. No. 10,167,903 (“the '903 patent”) describes a dual clutch. The '903 patent describes that the dual clutch can include a first partial clutch for coupling a drive shaft to a first transmission input shaft, and a second partial clutch to couple the drive shaft to a second transmission input shaft. According to the '903 patent, a first actuating cup displaces a first compression plate of the first partial clutch and a second actuating cup displaces a second compression plate of the second partial clutch.

### SUMMARY

According to one or more aspects of the present disclosure, a torque device assembly is disclosed or can be provided or implemented. The torque device assembly can comprise: at least one plate having a first face and a second face opposite the first face; and a piston to slidingly engage and disengage with the first face of the at least one plate. A face of the piston can selectively engage the first face of the at least one plate. The face of the piston can have a first portion that faces the first face of the at least one plate and that contacts the first face of the at least one plate in a case where the piston engages the at least one plate. The face of the piston can have a second portion that faces the first face of the at least one plate and that does not contact the first face of the at least one plate in the case where the piston engages the at least one plate. The first portion of the face of the piston that contacts the first face of the at least one plate in the case where the piston engages the at least one plate can be at a tip of the piston.

According to one or more aspects of the present disclosure, a method is disclosed or can be implemented. The method can comprise: providing a clutch pack; and providing a piston relative to a first end of the clutch pack to selectively engage and disengage the clutch pack. The clutch pack can be compressible responsive to engagement of the piston against an end plate of the clutch pack. A first face of the piston can be selectively engageable with a contact face of the end plate of the clutch pack that faces the first face of the piston. The first face of the piston can have a first portion that faces the contact face of the end plate of the clutch pack and that can contact the contact face of the end plate of the clutch pack when the piston engages the clutch pack. The first face of the piston can have a second portion that faces the contact face of the end plate and that does not contact the contact face of the end plate of the clutch pack when the piston engages the clutch pack. The first portion of the first face of the piston that contacts the contact face of the end plate when the piston engages the clutch pack can be at a tip of the piston.

According to yet one or more aspects of the present disclosure, a system for selectively engaging and disengaging a clutch is disclose or can be provided or implemented. The system can comprise: a clutch pack comprised of a plurality of alternating friction discs and plates and in a clutch drum; and a piston to selectively engage and disengage the clutch pack. The clutch pack can be compressible at a first end toward a second stationary end opposite the first end responsive to engagement of the piston against an end plate of the clutch pack. A first face of the piston can selectively engage a contact face of the end plate of the clutch pack that faces the first face of the piston. The first face of the piston can have a first portion that faces the contact face of the end plate and that can contact the contact face of the end plate when the piston engages the clutch pack. The first face of the piston can have a second portion that faces the contact face of the end plate and that does not contact the contact face of the end plate when the piston engages the clutch pack. The first portion of the first face of the piston that contacts the contact face of the end plate when the piston engages the clutch pack can be at a tip of the piston.

### BRIEF DESCRIPTION OF DRAWINGS

FIG. 1 depicts a machine according to one or more embodiments of the disclosed subject matter.

FIG. 2 depicts a block diagram of a transmission system according to one or more embodiments of the disclosed subject matter.

FIG. 3 depicts in cross section a portion of the transmission system according to one or more embodiments of the disclosed subject matter.

FIG. 4 depicts in cross section a portion of a clutch in the portion of the transmission system of FIG. 3.

FIG. 5 depicts in cross section the portion of the clutch of FIG. 4 with a piston engaging a clutch pack.

FIGS. 6A-6D show exemplary piston tips and interfacings between the pistons and a clutch pack according to embodiments of the disclosed subject matter.

FIG. 7A shows an example of conventional computer simulated thermal loading for a clutch pack engaged by a piston.

FIG. 7B shows exemplary computer simulated thermal loading for a clutch pack engaged by a piston according to one or more embodiments of the disclosed subject matter.

FIG. 8 is a flow chart of a method according to one or more embodiments of the disclosed subject matter.

### DETAILED DESCRIPTION

The present disclosure relates to torque devices, particularly torque devices (e.g., clutch or brake) in transmissions or braking systems.

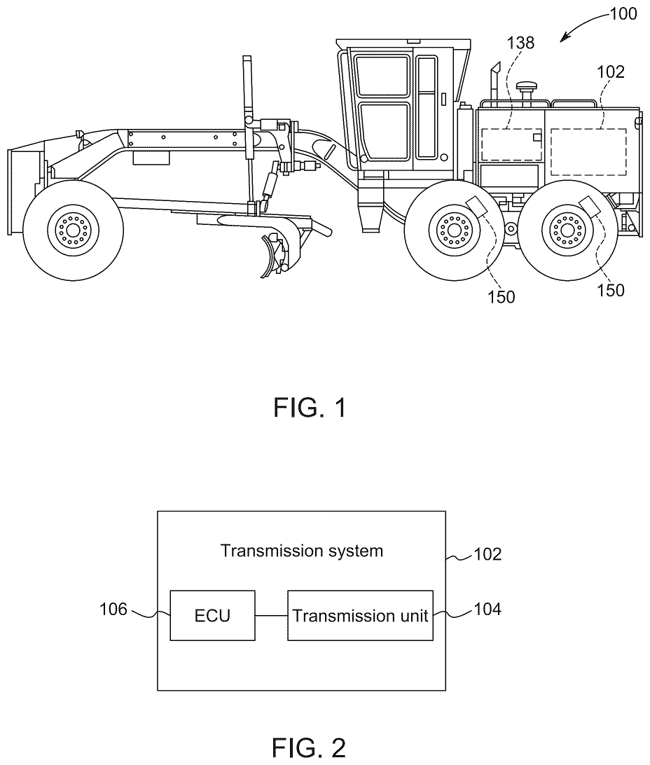

FIG. 1 depicts a machine 100 according to embodiments of the disclosed subject matter. The machine 100 can comprise a transmission system 102 and an engine 138. The machine 100 can also comprise a braking system 150.

In FIG. 1 the machine 100 is shown as a motor grader. However, in alternate embodiments, the machine 100 can be another working machine, such as a track-type tractor, a wheel loader, a haul truck (e.g., articulated or non-articulated dump truck), a large mining truck, an off-highway truck, and the like. Furthermore, the machine 100 may embody any wheeled or tracked machine associated with mining, agriculture, forestry, construction, and other industrial applications. Generally, the engine 138 can provide rotational power to the transmission system 102, which can receive the rotational power from the engine 138 and selectively transfer rotational power to the wheels of the machine 100 (the term “wheels” is used broadly and encompasses endless track assemblies and other motive configurations). The braking system 150, generally, can prevent the machine 100 from moving under the power of the engine 138. The braking system 150 may also be used to decelerate and stop the machine 100.

The engine 138 may be an internal combustion engine such as a reciprocating piston engine or a gas turbine engine. In an embodiment, the engine 138 can be a spark ignition engine or a compression ignition engine. The compression ignition engine can be a diesel engine, a homogeneous charge compression ignition engine, or a reactivity-controlled compression ignition engine, as examples.

As seen in FIG. 2, the transmission system 102 can comprise a transmission 104 (which may be referred to as a transmission unit, a transmission assembly, or a transmission module) and an electronic control unit (“ECU”) 106. The ECU 106, which can include a processor and memory, can be implemented in or using circuitry. The ECU 106 can control one or more operations of the transmission 104. In an embodiment, the ECU 106 can comprise clutch logic.

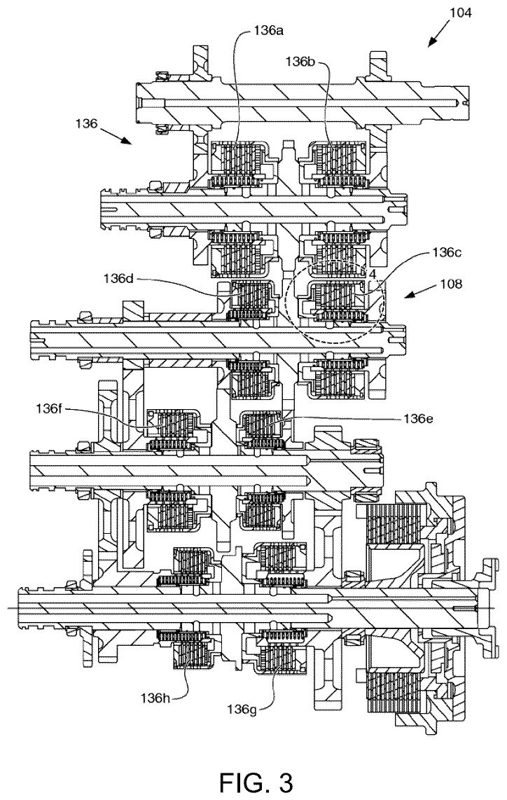

Referring now to FIG. 3, the transmission 104 can comprise a plurality of clutches 136 such as the clutches 136a-136h. The clutches 136a-136h can be utilized during different speeds of the machine 100 and even for different directions of travel of the machine 100. In an embodiment, the transmission 104 can be or comprise a countershaft transmission. Each clutch 136, or portions thereof, may be referred to or characterized as a torque device or assembly. Torque devices or torque device assemblies, according to embodiments of the disclosed subject matter, may also be brake devices or assemblies, for instance, single- or multi-disc brakes of the braking system 150.

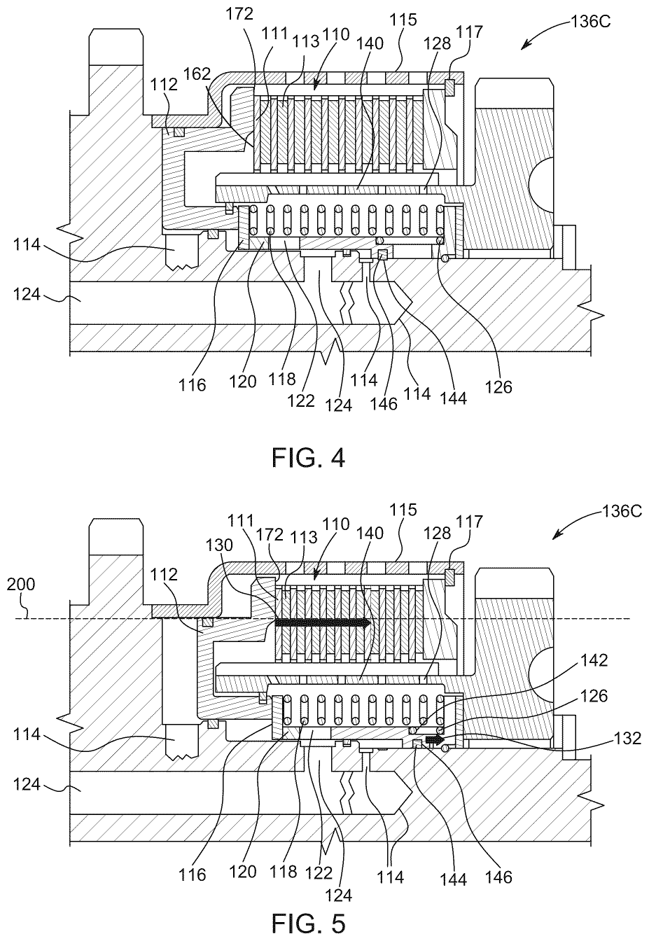

A portion of the clutch 136c in FIG. 3 can be seen in FIG. 4 as indicated by the section 108 in FIG. 3. As shown in FIG. 4, the clutch 136c can comprise a clutch pack 110 which can be engaged by a piston 112. The clutch pack 110 can comprise one or more clutch discs and plates. The clutch discs and plates can be slidably movable in a longitudinal direction of the clutch pack 110 by the piston 112 when the piston 112 engages the clutch pack 110.

The piston 112 can be connected to a clutch fluid passage 114 to receive clutch fluid. The clutch fluid can aid in actuating the piston 112 to engage or disengage the clutch pack 110. That is, as pressure of the clutch fluid is increased, the piston 112 can move toward and engage the clutch pack 110. Similarly, as the pressure of the clutch fluid is decreased, the piston 112 can move away from and disengage the clutch pack 110. In an embodiment, the clutch fluid can comprise clutch oil. According to one or more embodiments of the disclosed subject matter, the piston 112 can directly contact the clutch pack 110 when engaged. The foregoing describes a pressure applied/spring retracted piston setup. However, embodiments of the disclosed subject matter are not so limited. Rather, embodiments of the disclosed subject matter can also involve or include a spring applied/pressure released piston setup.

According to one or more embodiments, the piston 112 can contact a piston plate 116, for instance, in continuous contact with the piston plate 116 when the piston 112 is engaged and disengaged with/from the clutch pack 110. The piston plate 116 can be biased towards the piston 112 by a piston retraction spring 118, and the piston plate 116 can transfer force from the piston 112 to a slider valve 120 when the piston 112 engages the clutch pack 110. The slider valve 120 can be infinitely moveable between an open position and a closed position. The slider valve 120 can also be in fluid communication with a lube oil passage 124 and the clutch fluid passage 114. In FIG. 4, the lube oil passage 124 and the fluid passage 114 can be spaced apart in the shaft and the broken lines depict that the passages are not connected to another. However, they are shown adjacent one another in the interest of brevity.

In this example, the slider valve 120 can also define an aperture 122, which can be at least partially aligned with the lube oil passage 124 when the slider valve 120 is in the open position. In such a case, the lube oil from the lube oil passage 124 can flow through the aperture 122. Subsequently, the lube oil can flow through apertures 128 defined by a hub 140 onto the clutch pack 110. The hub 140 can partially enclose the slider valve retraction spring 126 and the slider valve 120.

The slider valve 120 can also comprise a first end and a second end opposite the first end. The aperture 122 can be located at or near the first end of the slider valve 120, while the slider valve retraction spring 126 can contact the slider valve 120 at or near the second end of the slider valve 120. Furthermore, the aperture 122 can face a direction substantially perpendicular to a direction in which the slider valve 120 slides.

The slider valve 120 can also define a slot 142 and a slot 144. In an embodiment, the slots 142 and 144 can each comprise an annulus. The slider valve retraction spring 126 can contact the slider valve 120 at the slot 142. A seal 146 can be located within the slot 144. The seal 146 can prevent clutch fluid from the clutch fluid passage 114 from entering past the seal 146. The seal 146 can comprise a rubber seal, which can move along with the slider valve 120.

When the slider valve 120 is in the closed position, the aperture 122 may not be aligned with the lube oil passage 124. In such a case, the slider valve 120 can prevent the lube oil from the lube oil passage 124 from flowing to the clutch pack 110. In addition to the pressure supplied by the piston 112 and the piston plate 116, the slider valve 120 can also be in an open or closed position based on the pressure by the clutch fluid. The pressure by the clutch fluid can be controlled by the ECU 106. For example, the ECU 106 can increase or decrease pressure by the clutch fluid. Referring now to FIG. 5, for engagement, when the pressure by the clutch fluid is greater than a first predetermined pressure threshold, the piston 112 can engage the clutch pack 110. FIG. 5 shows the movement of the piston 112 indicated by the arrow 130.

Referring still to FIG. 4 and FIG. 5, as noted above, the clutch pack 110 can be comprised of a plurality of alternating discs 113 and plates 111. The discs 113 may be referred to or characterized as friction discs, because when the piston 112 engages the clutch pack 110 the discs 113 can frictionally engage the plates 111 and prevent rotation. The plates 111 may be referred to or characterized as rotatable plates, because they can be rotatable at least when the piston 112 is not engaged with the clutch pack 110. This can also apply in the context of a brake as the torque device (e.g., of braking system 150), meaning that the brake disc, which is rotatable, can be prevented from rotating at least when the piston of the brake is fully engaged, i.e., with sufficient braking pressure applied, and the vehicle is stopped. Alternatively, some or all of the plates 111 may not rotate relative to the piston 112.

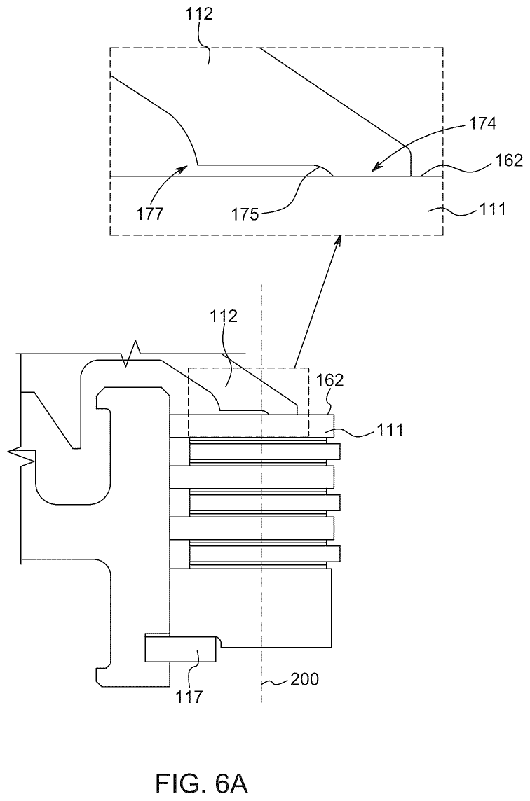

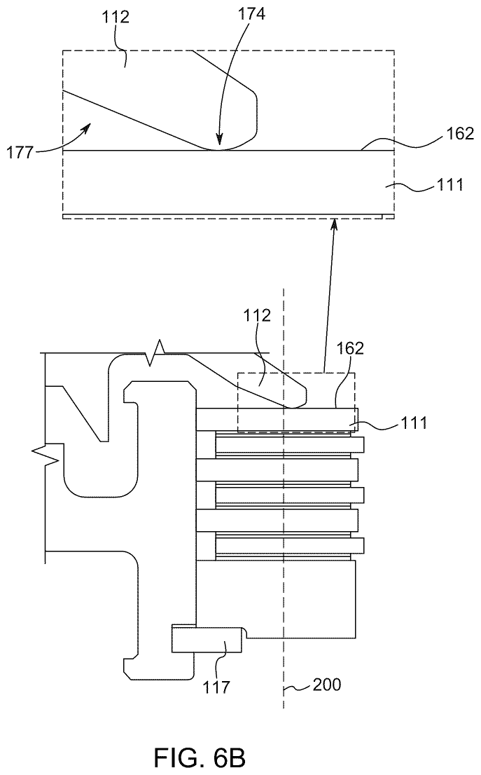

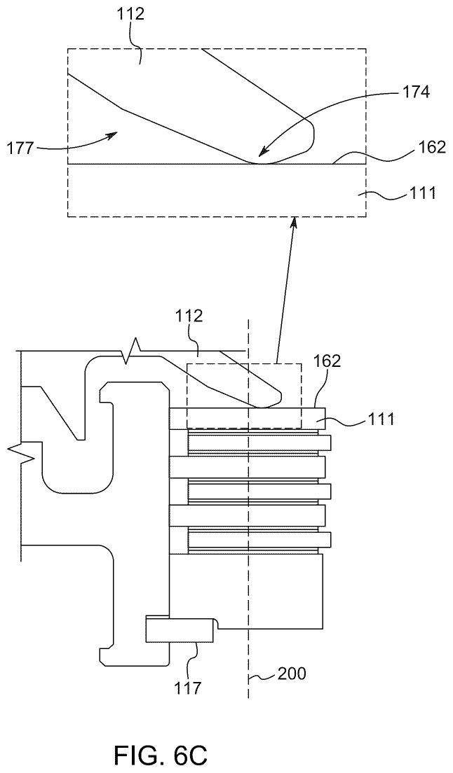

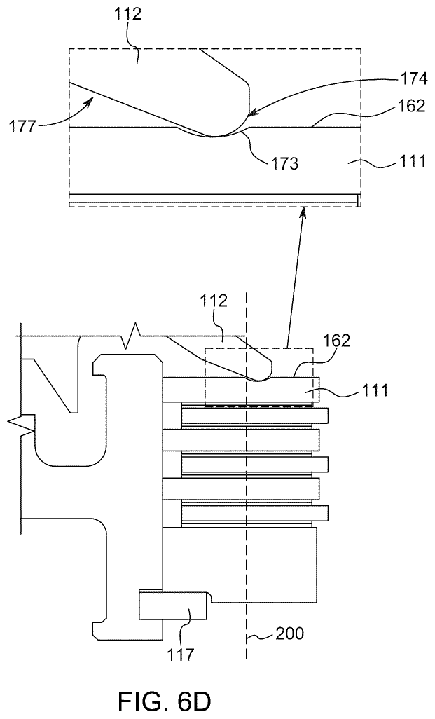

The clutch pack 110 may be provided in a clutch drum 115. According to one or more embodiments, a retaining ring 117 can retain (or assist in retaining) the clutch pack 110 in the clutch drum 115. As shown in FIG. 4 and FIG. 5, according to one or more embodiments, the retaining ring 117 can be at an outer diameter (OD) of the clutch pack 110, though embodiments of the disclosed subject matter are not so limited. For instance, FIGS. 6A-6D show the retaining ring 117 at an inner diameter (ID) of the clutch pack 110.

A plate 111 of the clutch pack 110 closest to the piston 112 can be referred to or characterized as an end plate (of the clutch pack 110). The plate 111 closest to the piston 112 can have a face or side 162 that faces the piston 112 and another face or side opposite the face 162 (see FIGS. 6A-6D). The face or side 162 may be referred to or characterized as a contact face 162 or first face or side 162. The piston 112 can have a face 172 and can slide to engage the clutch pack 110 such that the face 172 of the piston 112 engages the first face 162 of the plate 11 of the clutch pack 110. The force of the piston 112 against the clutch pack 110 at a first end of the clutch pack 110 can cause the clutch pack 110 to compress toward a second, stationary end of the clutch pack 110. As shown in FIG. 5, the piston 112 can push the clutch pack 110 in the direction of the arrow 130 for engagement of the clutch pack 110.

Referring now specifically to FIGS. 6A-6D, the face 172 of the piston 112 can have a first portion 174 and a second portion 177. The first portion 174 and the second portion 177 of the face 172 of the piston 112 can face the plate 111 at the end of the clutch pack 110 closest to the piston 112. When the piston 112 engages the clutch pack 110, the first portion 174 of the face 172 can contact the plate 111. However, when the piston 112 engages the clutch pack 110 the second portion 177 does not contact the plate 111. Here, as shown in FIGS. 6A-6D, the first portion 174 of the face 172 of the piston 112 can be at a projecting tip or end of the piston 112. In this regard, the second portion 177 of the face 172 of the piston 112 can be offset or spaced from the projecting tip or end of the piston 112. That is, the second portion 177 of the face 172 of the piston 112 that does not contact the plate 111 when the piston 112 engages the clutch pack 110 can be offset or spaced from the projecting tip or end of the piston 112.

As can be seen from FIGS. 6A-6D, the first portion 174 of the face 172 of the piston 112 can be non-linear, at least in part. For instance, FIG. 6A shows, in a cross-sectional view, that the first portion 174 can have a step 175 that transitions to the second portion 177. According to one or more embodiments, the first portion 174 of the face 172 can be planar from the outer edge or outer diameter (OD) of the piston 112 to the step 175, such as shown in FIG. 6A. Opposite ends of the step (in the cross-sectional view) can be rounded (such as shown in FIG. 6A) or sharp. As other examples, FIGS. 6B-6D show, in the cross-sectional view, that the first portion 174 can be continuously curved. In these examples, the first portion 174 may be characterized as convex.

According to one or more embodiments, the face 162 of the plate 111 can be planar from an outer edge or outer diameter (OD) of the plate 111 to an inner edge or inner diameter (ID) of the plate 111, such as shown in FIGS. 6A-6C. Alternatively, the face 162 of the plate 111 can have a recessed portion 173, for instance, sized and positioned to accommodate some or all of the first portion 174 of the face 172 of the piston 112 at least when the piston 112 engages the clutch pack 110. For instance, FIG. 6D shows the recessed portion 173 as concave, with a radius of curvature greater than a radius of curvature of the first portion 174 of the face 172 of the piston 112. The recessed portion 173 can ensure that the first portion 174 of the face 172 of the piston 112 is properly located or aligned relative to the clutch pack 110, particularly when the piston 112 engages the clutch pack 110. Optionally, some or all of the face 162 (e.g., some or all of the recessed portion 173, when present) can be surface hardened or wear coated.

When the piston 112 engages the clutch pack 110, the first portion 174 of the face 172 of the piston 112 can contact the face 162 of the plate 111 radially inward of a center line 200 extending longitudinally through the clutch pack 110, such as shown in FIG. 5. In this example, some of the first portion 174 contacts the face 162 of the plate 111 radially inward of the center line 200 and some of the first portion 174 contacts the face 162 of the plate 111 radially outward of the center line 200. Alternatively, when the piston 112 engages the clutch pack 110, the first portion 174 of the face 172 of the piston 112 can contact the face 162 of the plate 111 radially outward of the center line 200, such as shown in FIGS. 6A-6D. In these examples, the first portion 174 of the face 172 of the piston 112 can contact the face 162 of the plate 111 only radially outward of the center line 200. According to one or more embodiments, when the retaining ring 117 is radially inward, at the inner diameter (ID) of the clutch pack 110, the first portion 174 of the face 172 of the piston 112 can contact the face 162 of the plate 111 at the center line 200 and/or radially outward of the center line 200, whereas when the retaining ring 117 is radially outward, at the outer diameter (OD) of the clutch pack 110, the first portion 174 of the face 172 of the piston 112 can contact the face 162 of the plate 111 at least radially inward of the center line 200. Examples of the latter case include the example shown in FIG. 5 and a case where the first portion 174 of the face 172 of the piston 112 contacts the face 162 of the plate 111 at the center line 200 and radially inward to the inner diameter (ID) of the plate 111. Generally, where the first portion 174 of the face 172 of the piston 112 contacts the face 162 of the plate 111 can be from the inner diameter (ID) to the outer diameter (OD) of the plate 111 based on stiffness of the clutch pack 110 and whether the clutch pack 110 is being retained at the inner diameter (ID) or the outer diameter (OD) thereof. Such arrangement may be to better distribute the compression forces throughout the clutch pack 110.

### INDUSTRIAL APPLICABILITY

The present disclosure relates to torque devices, particularly torque devices (e.g., clutch or brake) in transmissions or braking systems.

Torque devices, upon engagement by a piston, can have a part that deflects. For instance, in the case of a clutch the clutch pack can deflect upon engagement by the piston. Such deflection can create a relatively high concentrated load on the friction material engaged by the piston. The deflection can also result relatively in high localized temperatures during engagement.

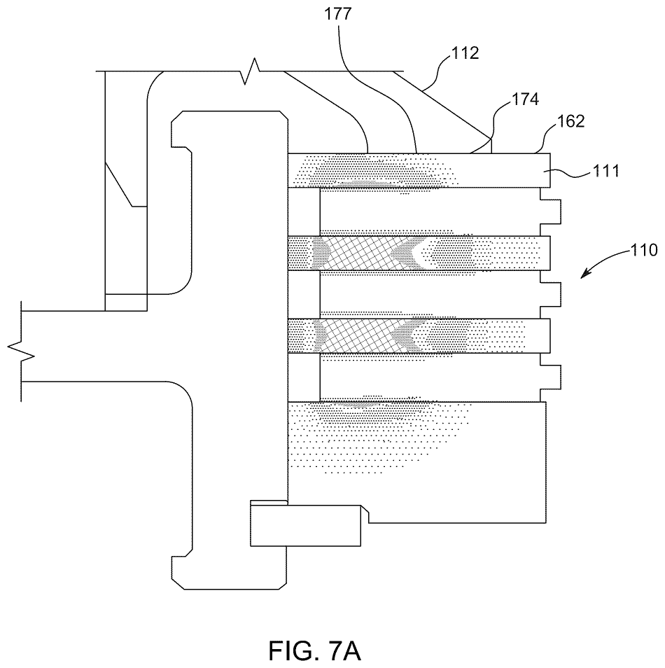

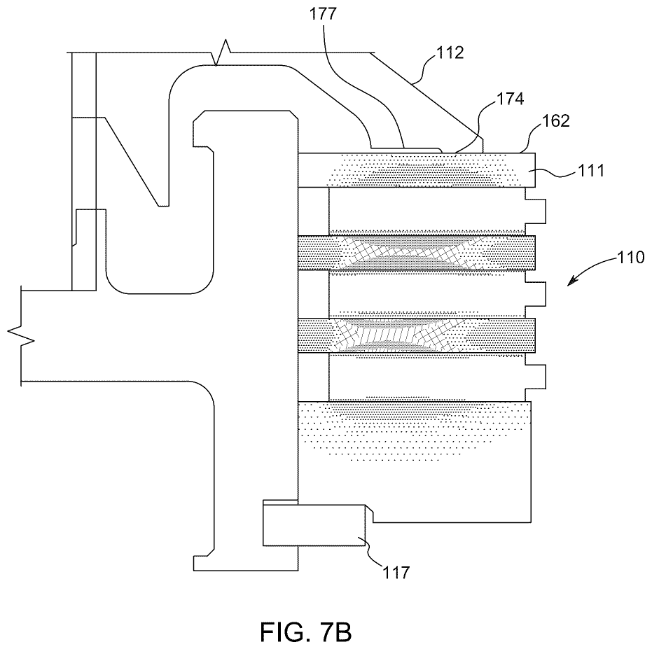

Embodiments of the disclosed subject matter can involve a so-called pivot piston in a torque device (e.g., clutch or brake). Generally, a pivot piston can operate by allowing a clamping surface to rotate about a radius when the part is deflected by relatively high forces. Only a projecting portion on the face of the piston, which can be at the tip or end portion of the piston, can contact the reaction plate. Such specific contact can reduce the contact pressure, for instance, compared to a flat faced piston, and, furthermore, can reduce localized high temperatures by applying load uniformly. This can result in lower temperature when the piston is engaged. FIG. 7B shows exemplary computer simulated thermal loading for a clutch pack engaged by a piston according to one or more embodiments of the disclosed subject matter. Notably, the piston engagement of the clutch pack according to embodiments of the disclose subject matter can cause the clutch pack to engage more evenly, which can spread out the heat and result in lower temperatures and lower pressure across the clutch material face, for instance, in comparison to conventional technology such as shown in FIG. 7A.

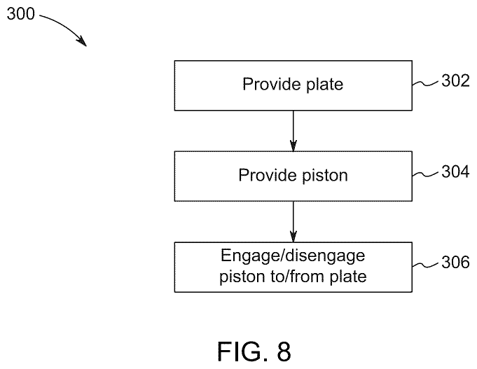

FIG. 8 is a flow chart of a method 300 according to one or more embodiments of the disclosed subject matter.

At 302, the method 300 can provide at least one plate, which can be rotatable. As noted above, the plate can be in the context of a torque device in the form of a clutch pack of a transmission, such as clutch pack 110, or a disc of a brake (e.g., a single- or multiple-disc brake) of a braking system, such as the braking system 150. At 304, the method 300 can provide a piston, such as piston 112. At 306, the method 300 can selectively engage the piston against the plate. The piston can be selectively engageable to slow down, stop, or prevent rotation of the plate, depending upon the type of torque device. In the context of the clutch pack, the piston can engage an end plate to press the discs of the clutch pack together to rotationally lock the discs. In the context of a disc brake, the piston can engage the plate/disc to slow down, stop, or prevent rotation of the plate/disc.

As noted above, engagement of the piston 112 against the plate 111 can be such that when the piston 112 engages the clutch pack 110, the first portion 174 of the face 172 of the piston 112 can contact the plate 111 and such that the second portion 177 does not contact the plate 111.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

While aspects of the present disclosure have been particularly shown and described with reference to the embodiments above, it will be understood by those skilled in the art that various additional embodiments may be contemplated by the modification of the disclosed machines, assemblies, systems, and methods without departing from the spirit and scope of what is disclosed. Such embodiments should be understood to fall within the scope of the present disclosure as determined based upon the claims and any equivalents thereof.

1. A system for selectively engaging and disengaging a clutch comprising:
a clutch pack comprised of a plurality of alternating friction discs and plates and in a clutch drum; and
a piston to selectively engage and disengage the clutch pack,
wherein the clutch pack is compressible at a first end toward a second stationary end opposite the first end responsive to engagement of the piston against an end plate of the clutch pack,
wherein a first face of the piston is to selectively engage a contact face of the end plate of the clutch pack that faces the first face of the piston,
wherein the first face of the piston has a first portion that faces the contact face of the end plate and that contacts the contact face of the end plate when the piston engages the clutch pack,
wherein the first face of the piston has a second portion that faces the contact face of the end plate and that does not contact the contact face of the end plate when the piston engages the clutch pack,
wherein the first portion of the first face of the piston that contacts the contact face of the end plate when the piston engages the clutch pack is at a tip of the piston,
wherein the first portion of the first face of the piston contacts the contact face of the end plate radially outward of a longitudinal center line of the contact face of the end plate when the piston engages the clutch pack,
wherein the second portion forms an inner edge of the first face, the first portion forms an outer edge of the first face opposite the inner edge, and the second portion extends radially outward from the inner edge toward the first portion, and
wherein the piston extends inward from the inner edge of the first face thereof.

2. The system according to claim 1, wherein the first portion of the first face of the piston is convex.

3. The system according to claim 2, wherein the contact face of the end plate has a concave recess formed therein that is sized and positioned to accommodate the first portion of the first face that is convex when the piston engages the clutch pack.

4. The system according to claim 2, wherein the contact face of the end plate is planar from an outer edge of the end plate to an inner edge of the end plate.

5. The system according to claim 1, wherein the first portion of the first face of the piston is planar from an outer edge of the piston to a step of the second portion of the first face of the piston.

6. The system according to claim 1, wherein the first portion of the first face of the piston is non-planar.

7. The system according to claim 1, further comprising a retaining ring at an outer diameter of the clutch pack to retain the clutch pack in the clutch drum.

8. The system according to claim 1, further comprising a retaining ring at an inner diameter of the clutch pack to retain the clutch pack in the clutch drum.

9. A method comprising:
providing a clutch pack; and
providing a piston relative to a first end of the clutch pack to selectively engage and disengage the clutch pack,
wherein the clutch pack is compressible responsive to engagement of the piston against an end plate of the clutch pack,
wherein a first face of the piston is selectively engageable with a contact face of the end plate of the clutch pack that faces the first face of the piston,
wherein the first face of the piston has a first portion that faces the contact face of the end plate of the clutch pack and that contacts the contact face of the end plate of the clutch pack when the piston engages the clutch pack,
wherein the first face of the piston has a second portion that faces the contact face of the end plate and that does not contact the contact face of the end plate of the clutch pack when the piston engages the clutch pack,
wherein the first portion of the first face of the piston that contacts the contact face of the end plate when the piston engages the clutch pack is at a tip of the piston,
wherein the first portion of the first face of the piston contacts the contact face of the end plate radially outward of a longitudinal center line of the contact face of the end plate when the piston engages the clutch pack,
wherein the second portion forms an inner edge of the first face and the first portion forms an outer edge of the first face opposite the inner edge,
wherein the piston extends inward from the inner edge of the first face thereof, and
wherein a portion of the second portion is at the longitudinal center line of the contact face.

10. The method according to claim 9, further comprising engaging the first portion of the first face of the piston against the contact face of the end plate of the clutch pack without the second portion of the first face of the piston contacting the contact face of the end plate of the clutch pack.

11. The method according to claim 10, wherein the first portion of the first face of the piston is convex.

12. The method according to claim 9, further comprising providing a retaining ring at an outer diameter of the clutch pack to retain the clutch pack.

13. The method according to claim 9, further comprising providing a retaining ring at an inner diameter of the clutch pack to retain the clutch pack.

14. A torque device assembly comprising:
at least one plate having a first face and a second face opposite the first face; and
a piston to slidingly engage and disengage with the first face of the at least one plate,
wherein a face of the piston is selectively engageable with the first face of the at least one plate,
wherein the face of the piston has a first portion that faces the first face of the at least one plate and that contacts the first face of the at least one plate in a case where the piston engages the at least one plate,
wherein the face of the piston has a second portion that faces the first face of the at least one plate and that does not contact the first face of the at least one plate in the case where the piston engages the at least one plate,
wherein the first portion of the face of the piston that contacts the first face of the at least one plate in the case where the piston engages the at least one plate is at a tip of the piston,
wherein the first portion of the face of the piston contacts a contact face of the end plate radially outward of a longitudinal center line of the contact face of the end plate when the piston engages a clutch pack,
wherein the second portion forms an inner edge of the face of the piston and the first portion forms an outer edge of the face of the piston opposite the inner edge,
wherein the piston extends inward from the inner edge of the face thereof, and
wherein the first portion of the face of the piston contacts the first face of the at least one plate only entirely radially outward of the longitudinal center line in the case where the piston engages the at least one plate.

15. The torque device assembly according to claim 14, wherein the torque device assembly is part of a transmission of a vehicle.

16. The torque device assembly according to claim 14, wherein the torque device assembly is part of a brake of a vehicle.

17. The torque device assembly according to claim 14,
wherein the at least one plate is part of a clutch pack, and
wherein the clutch pack is compressible at a first end toward a second stationary end opposite the first end responsive to engagement of the piston against the at least one plate.

18. The torque device assembly according to claim 14,
wherein the first portion of the face of the piston is convex, and
wherein the first face of the at least one plate has a concave recess formed therein that is sized and positioned to accommodate the first portion of the face of the piston that is convex in the case where the piston engages the at least one plate.

19. The torque device assembly according to claim 14, wherein the first portion of the face of the piston is planar from an outer edge of the piston to a step of the second portion of the face of the piston.

20. (canceled)
